(19) United States
(12) Patent Application Publication
(10) Pub. No.: US 2017/0161798 A1
(43) Pub. Date: Jun. 8, 2017

(54) SYSTEM AND METHOD FOR ASSESSING DATA FOR A SPECIFIED PRODUCT/SERVICE

(71) Applicant: STRATHSPEY CROWN HOLDINGS, LLC, Newport Beach, CA (US)

(72) Inventors: Robert Edward Grant, Laguna Beach, CA (US); Jennifer Mons, Mission Viejo, CA (US); Benjamin Wade Judge, Irvine, CA (US)

(21) Appl. No.: 14/962,890

(22) Filed: Dec. 8, 2015

(51) Int. Cl. G06Q 30/02; G06F 17/30

(52) U.S. Cl. CPC G06Q 30/0282; G06Q 30/0203; G06F 17/30528

(57) ABSTRACT

Computer-based systems and methods are provided which combine subjective and objective evaluations of a specified product/service for use as a comprehensive assessment of the product/service. The subjective evaluation is made by polling the opinions of a selected plethora of competent commentators. These opinions are then tempered by personal profiles of the respective commentators to create subjectively informed comments. On the other hand, the objective valuation is based on available physical data that is pertinent to the product/service. When evaluated together, the subjective and objective evaluations combine to create weighted comments that can be presented in a suitable manner for public and personal review.

### FIELD OF THE INVENTION

The present invention pertains to computer-based systems and methods for evaluating and assessing the commercial attributes of a specified product/service. More specifically, the present invention pertains to systems and methods for subjectively evaluating opinions from a plethora of competent commentators regarding technical, practical and competitive aspects of a particular commercial product/service. The present invention is particularly, but not exclusively, useful for systems and methods that augment a subjective evaluation of a product/service with an objective evaluation of the product/service based on available data that pertains to physical criteria (e.g. measurements, valuations, performance capabilities) of the product/service.

### BACKGROUND OF THE INVENTION

Neither a subjective evaluation nor an objective evaluation of anything is particularly persuasive when done separately. Always, a combination of the two is clearly preferable. Any subjective evaluation, however, is vulnerable to bias, and every objective evaluation can potentially suffer from the availability of incomplete information. Consequently, there is always a clear need for as much good (i.e. accurate and complete) information as possible. As a practical matter, time constraints can put limits on the ability to retrieve the needed information with which to make an informed decision. In such situations the compilation of a meaningful subjective application can become particularly problematic.

In the effort to obtain a sufficient amount of meaningful information with which to make a commercial evaluation (assessment) of a product/service, it is necessarily preferable to rely on a comprehensive subjective evaluation of the matter. In particular, it is desirable to rely on the considered opinions of as many competent commentators as possible. In any case, it is necessary that the individual comments which comprise this subjective evaluation must each be pertinent, credible, and authoritative.

Information technology today has advanced to the point where vast amounts of information can be transferred almost instantaneously. The trick here is to first identify authoritative sources of pertinent information, and to then direct analytical inquiries to the appropriate sources. It follows that a compilation of responses from these various sources can be edited and presented for a comprehensive review. As envisioned for the present invention these tasks are all directed to the commercial evaluation (assessment) of a specified product/service.

With the above in mind, it is an object of the present invention to provide a computer-based system and method for interactively using information to assess and evaluate a specified product/service that relies on both a subjective and an objective evaluation of a specified product/service. Another object of the present invention is to provide a computer-based subjective evaluation of a product/service that is based on a plethora of competent individual opinions wherein each individual opinion is pertinent, credible, and authoritative. Still another object of the present invention is to provide a computer-based system and method for interactively using information to assess and evaluate a specified product/service that is easy to implement, is simple to use and is cost effective.

### SUMMARY OF THE INVENTION

A system and method for using information to assess and evaluate a specified product/service in accordance with the present invention involves an objective/subjective evaluation of the product/service. For the objective portion of the evaluation an appraisal is made of selected physical attributes of the product/service. This objective appraisal is dependent on the extent to which such data is available and, in the case of new and innovative products/services, it may happen that data is unavailable. If available, however, the objective appraisal will typically include test evaluations, trial results (e.g. clinical trials), and commercial comparisons that are determined and measured using physical criteria. On the other hand, the subjective portion of the evaluation is based on polling data obtained from a selectively defined constituency. This subjective data will typically include comments and opinions regarding the product/service which are obtained from competent individuals. Importantly, these subjective comments and opinions will be based on the personal experience and knowledge of each individual. The present invention then gives weight to the subjectively obtained comments and considers them together with the objective appraisal, if it is available. The result of this is a survey review (i.e. publication) which includes a responsive evaluation of the product/service.

In detail, a system for the present invention includes a computer and an analyzer which simultaneously receive a same inquiry about a specified product/service. For the present invention, this inquiry may originate from anyone having access to the system. As set for below, this inquiry will be processed by the computer differently than by the analyzer. In overview, the computer is used to make an objective evaluation of the product/service, while the analyzer is involved with a subjective evaluation of the product/service. The subjective evaluation is considered here first.

Once an inquiry has been received by the analyzer, it prepares a questionnaire that is based on the inquiry. Necessarily, the questionnaire will contain at least one question which pertains to an identified attribute of the product/service. Multiple choice answers to the question are then prepared. Depending on the particular product/service, and the nature of the inquiry, there may be a plurality of questions developed for the questionnaire, and each question will then have its own set of multiple choice answers. It is also to be appreciated that other questionnaire formats may be used. For instance, the questionnaire may solicit written comments and/or identification of known documentation pertinent to the product/service.

After the questionnaire has been prepared, it is then passed to a plurality of competent members in a defined community, for their respective review and comment. For purposes of the present invention, members of this defined community will typically be professionals, business-persons, and academics who have similar commercial investment interests, and who are familiar with the technical field of the product/service. The response from each member to questions in the questionnaire (i.e. answer selections) is used to create a member comment that is sent to a profiler.

A profiler is incorporated into the present invention for receiving a plurality of member comments from the analyzer. Additionally, the profiler receives input from a data base. In particular, the data base is provided for archiving member profiles and a plethora of voluntary comments. Specifically, the member profiles pertain to the unique qualifications and capabilities of each competent member who has provided a member comment. On the other hand, the voluntary comments pertain to a plurality of different products/services, and are provided by members in the defined community, at-large. For purposes of the present invention the member profiles and voluntary comments from the data base are selectively used by the profiler to temper each respective member comment. The result here is the creation of a subjectively informed comment regarding the inquiry.

As noted above, along with the analyzer, a computer also receives the inquiry. The purpose here is to have the computer create an objective appraisal of the service/product. In contrast with the subjectively informed comments created by the profiler, the objective appraisal created by the computer is based on test evaluations, clinical trials, and commercial comparisons which rely on objective criteria that are pertinent to the specified service/product.

An evaluator is connected to the profiler, and to the computer, for matching and evaluating the subjectively informed comment from the profiler with the objective appraisal from the computer. The consequence in this evaluation is the creation of a weighted comment. Weighted comments from all of the competent members that have answered the inquiry are then transferred to a sorting unit. At the sorting unit, the weighted comments are segregated into categories based on an assessment of predetermined aspects and attributes of the specified product/service. From the sorting unit, the weighted comments are subsequently transferred to the computer where they are edited, compiled, formatted and organized for a survey review (publication) that is presented in response to the inquiry. Typically, this survey review will provide a summary of the weighted comments, and can include a listing of these comments according to predetermine criteria (e.g. competency level for the comment).

As an additional feature of the present invention, the weighted comments can be returned to the profiler for future use with other member comments to create informed comments regarding future inquiries. Another optional feature can be a timer that is incorporated into the computer for establishing a time period for responding to a particular inquiry. Further, as envisioned for the present invention, the survey review (publication) can include information concerning pricing, efficacy and availability of the product/service.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic presentation of the operational components incorporated into a system of the present invention; and

FIG. 2 is an operational flow chart of the steps sequentially used for performing a method in accordance with the present invention.

### DESCRIPTION OF THE PREFERRED EMBODIMENTS

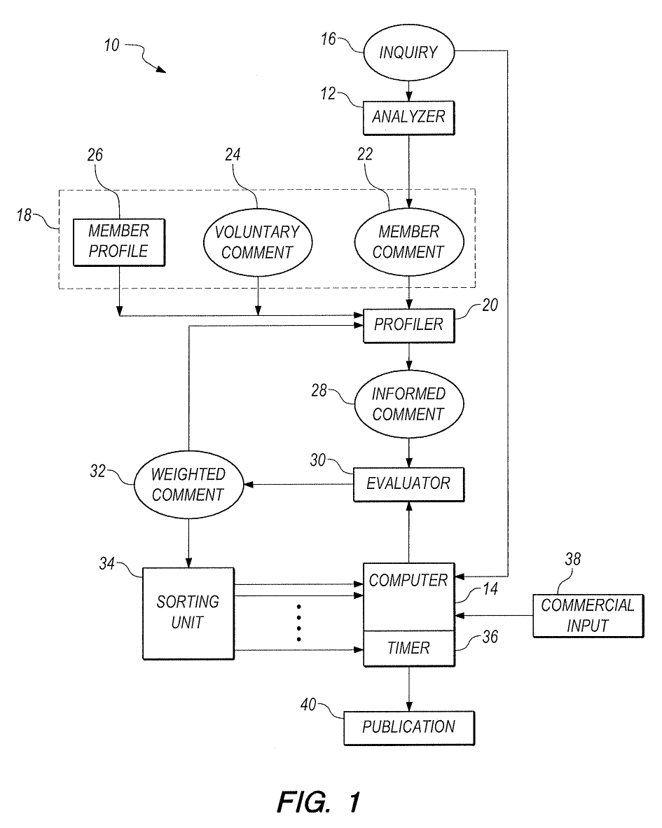

Referring initially to FIG. 1 a system for interactively using information to assess and evaluate a product/service in accordance with the present invention, is represented in a schematic of its operational components. In this schematic, the system is generally designated 10. As shown, the system 10 includes an analyzer 12 and a computer 14. Importantly, both the analyzer 12 and the computer 14 are provided to receive an inquiry 16 from an external entity (not shown). For purposes of the present invention, the inquiry 16 will pertain to a product/service (not shown) and it will typically be of commercial interest to the external entity.

In overview of the system 10, the analyzer 12 is provided to create a subjectively informed comment regarding the product/service that is the reason for inquiry 16. On the other hand, the computer 14 is provided to create an objective appraisal of the product/service. As disclosed in detail below, the analyzer 12 and the computer 14 are required, in combination, for the subjective/objective purposes of the system 10.

For the subjective perspective of the present invention, the analyzer 12 is used to prepare a questionnaire. This questionnaire will be is based on the inquiry 16, and it will typically include at least one question that pertains to a particular attribute of the product/service that is the basis of the inquiry 16. Also included in the questionnaire, will be a plurality of possible multiple-choice answers to the question. There may, of course, be a number of questions posed, with a respective number of multiple-choice answers for each question.

Once the questionnaire has been prepared, it is passed from the analyzer 12 to a plurality of competent members in a defined community 18. Each of the members that are identified by the analyzer 12 are to then select an answer(s) to the question(s) in the questionnaire. For purposes of the present invention, the identified members will typically be professionals, business-persons, and academics having technical and/or commercial investment interests in the product/service.

FIG. 1 also shows that a profiler 20 is included in the system 10. As shown, the profiler 20 is provided to receive input from the defined community 18. In particular, this input from the defined community 18 includes member comment(s) 22 which will include the questionnaire responses from individual members. For purposes of this disclosure, the member comment(s) 22 will be from those members of the defined community 18 that are identified by the analyzer 12. Input to the profiler 20, however, may also include unsolicited voluntary comment(s) 24 from members of the defined community 18 that are not specifically identified by the analyzer 12. In either case (i.e. member comment(s) 22 and voluntary comment(s) 24), a member profile 26 is provided.

Each member profile 26 will provide information regarding the unique qualification and capabilities of the particular member that has provided either member comment(s) 22 or voluntary comment(s) 24. The member profile 26 is then used by the profiler 20 to temper the respective member comment(s) 22 or voluntary comment(s) 24. The result here is the creation of a subjectively informed comment 28 regarding the inquiry 16.

It is to be appreciated that the profiler 20 may also include a data base for archiving the member profile(s) 26, as well as previous member comment(s) 22 and voluntary comment(s) 24. The archived materials will generally be from members in the defined community 18 and will refer to a plurality of different products/services. For all operations of the system 10, however, the data base is always accessible by the profiler 20 for a selective use of information from its database.

At the interface between the subjective aspect of the system 10 (i.e. analyzer 12 and profiler 18) and the objective aspect of the system 10 (i.e. computer 14) is the evaluator 30. As shown, the evaluator 30 receives input in the form of an informed comment(s) 28 from the profiler 20 and, as disclosed above, it receives a direct input in the form of an objective appraisal of the product/service from the computer 14. In particular, the objective appraisal is based on test evaluations, clinical trials, and commercial comparisons that pertain to the specified product/service. The evaluator 30 then matches and evaluates the subjectively informed comment(s) 28 from the profiler 20 with the objective appraisal from the computer 14 to establish a weighted comment 32.

System 10 also includes a sorting unit 34. As shown, the sorting unit 34 is connected with the evaluator 30 for receiving a plethora of weighted comments 32 regarding the product/service. At the sorting unit 34, the weighted comments 32 are segregated into categories which are based on an assessment of predetermined aspects and attributes of the specified product/service. Once they have been segregated, the weighted comments 32 are transferred to the computer 14 to be edited, compiled, formatted and organized.

Additional components of the system 10 may include a timer 36. As envisioned for the present invention, the timer 36 will be incorporated into the computer 14 for the purpose of establishing a time period within which to respond to a particular inquiry 16. FIG. 1 also shows that the computer 14 can receive commercial input 38 which may be of interest for use in generating the objective appraisal (disclosed above), and/or for use in the creation of a publication 40. As envisioned for the present invention, the publication 40 will typically include information concerning pricing, efficacy and availability of the product/service which has been identified in the inquiry 16.

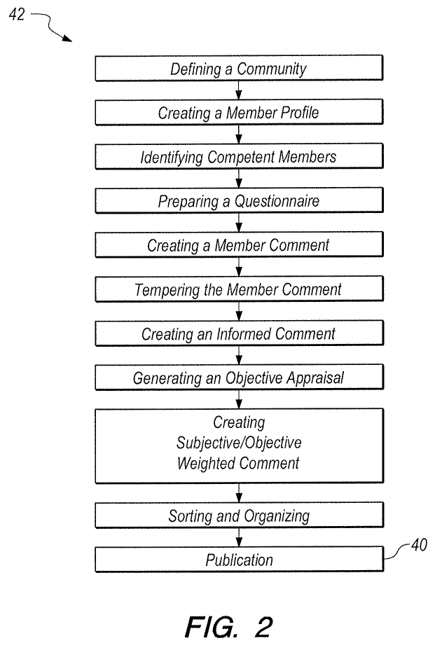

For an operation of the system 10, chart 42 in FIG. 2 shows a logical sequence of steps for assessing and evaluating a product/service in accordance with the present invention. The important consequence of this operation is the creation of the publication 40. As disclosed and claimed for the present invention, the publication 40 includes both subjective and objective considerations that are provided for a specified product/service from a wide variety of sources.

While the particular System and Method for Assessing Data for a Specified Product/Service as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for interactively using information to assess and evaluate a specified product/service in response to an inquiry about the product/service, the system comprising:
an analyzer for receiving an inquiry about a specified product/service and for preparing a questionnaire based on the inquiry, wherein the questionnaire contains at least one question pertaining to an attribute of the product/service together with multiple choice answers to the question, wherein the questionnaire is passed to a plurality of competent members in a defined community for selection of an answer by each member to the question in the questionnaire, and further wherein the answer is used to create a member comment;
a profiler for receiving a plurality of member comments from the analyzer and together with a respective member profile pertaining to unique qualifications and capabilities of the competent member who provides the member comment, wherein the member profile is used by the profiler to temper the member comment for creation of a subjectively informed comment regarding the inquiry;
a computer for receiving the inquiry to create an objective appraisal of the service/product, wherein the appraisal is based on test evaluations, clinical trials, and commercial comparisons pertaining to the specified product/service;
an evaluator connected to the profiler, and to the computer, for matching and evaluating the subjectively informed comment from the profiler with the objective appraisal from the computer to create a weighted comment; and
a sorting unit connected with the evaluator for receiving a plethora of weighted comments regarding the product/service, wherein the weighted comments are segregated into categories based on an assessment of predetermined aspects and attributes of the specified product/service, and are subsequently transferred to the computer for editing, compiling, formatting and organizing the categorized weighted comments for a survey review presented in response to the inquiry.

2. A system as recited in claim 1 wherein the weighted comments are returned to the profiler for future use with other member comments to create informed comments regarding future inquiries.

3. A system as recited in claim 1 wherein members of the defined community are selected from the group consisting of professionals, business-persons, and academics having similar commercial investment interests.

4. A system as recited in claim 1 further comprising a timer incorporated into the computer for establishing a time period for responding to a particular inquiry.

5. A system as recited in claim 1 further comprising a data base for archiving the member profiles and a plethora of voluntary comments from members in the defined community regarding a plurality of different products/services, wherein the data base is accessible by the profiler for a selective use of information from the database.

6. A system as recited in claim 1 wherein the publication includes information concerning pricing, efficacy and availability of the product/service.

7. A system as recited in claim 1 further comprising a source of commercial information for input into the computer for use in generating the objective appraisal.

8. A method for interactively using information to assess and evaluate a specified product/service in response to an inquiry about the product/service, the method comprising the steps of:
defining a community;
creating a member profile for each member in the defined community, wherein each member profile pertains to unique qualifications and capabilities of the particular member;
identifying competent members of the community for the specified product/service;
preparing a questionnaire based on the inquiry, wherein the questionnaire contains at least one question pertaining to an attribute of the product/service and multiple choice answers to the question;
passing the questionnaire to a plurality of competent members in the defined community for individual selection of an answer by each member to each question in the questionnaire for use of the answer in creating a member comment;
using a corresponding member profile for the respective competent member to temper the competent member's comment regarding the inquiry for creation of a subjectively informed comment;
generating an objective appraisal of the product/service pertinent to the inquiry;
matching the subjectively informed comment from the using step with the objective appraisal from the generating step to create a weighted comment;
sorting the weighted comments into categories based on an assessment of predetermined aspects and attributes of the particular product/service; and
organizing and editing the categorized weighted comments for publication in response to the inquiry.

9. A method as recited in claim 8 wherein the objective appraisal is based on information selected from the group consisting of test evaluations, clinical trials, and commercial comparisons.

10. A method as recited in claim 8 further comprising the step of returning weighted comments for consideration with member comments regarding future inquiries during the using step.

11. A method as recited in claim 8 further comprising the step of archiving member profiles and a plethora of voluntary comments from members in the defined community regarding a plurality of different products/services.

12. A method as recited in claim 8 wherein the steps of identifying and preparing are accomplished by a computer-based analyzer.

13. A method as recited in claim 8 wherein the using step is accomplished using a computer-based profiler.

14. A method as recited in claim 13 wherein the generating step is accomplished using a computer.

15. A method as recited in claim 14 wherein the matching step is accomplished using a computer-based evaluator.

16. A non-transitory, computer-readable medium having executable instructions stored thereon that direct a computer system to perform a process for assessing and evaluating a product/service which comprises:
preparing a questionnaire based on an inquiry, with the questionnaire containing at least one question pertaining to an attribute of the product/service, with multiple choice answers to the question;
passing the questionnaire to a plurality of competent members in a defined community for selection by each member of an answer to the question in the questionnaire for use in creating a member comment;
tempering the member comments with a respective member profile to create a subjectively informed comment regarding the inquiry;
creating an objective appraisal of the service/product;
matching and evaluating the subjectively informed comment from the profiler with the objective appraisal from the computer to create a weighted comment; and
organizing the weighted comments for publication in response to the inquiry.

17. A computer-readable medium as recited in claim 16 wherein the member profiles pertain to unique qualifications and capabilities of the respective member.

18. A computer-readable medium as recited in claim 16 wherein the objective appraisal is based on test evaluations, clinical trials, and commercial comparisons pertaining to the specified service/product.

19. A computer-readable medium as recited in claim 16 wherein the weighted comments are segregated into categories based on an assessment of predetermined aspects and attributes of the specified product/service for the publication.

20. A computer-readable medium as recited in claim 16 wherein members of the defined community are selected from the group consisting of professionals, business-persons, and academics having similar commercial investment interests.
